(19) United States
(12) Patent Application Publication
(10) Pub. No.: US 2009/0103294 A1
(43) Pub. Date: Apr. 23, 2009

(54) LED LAMP WITH A HEAT SINK

(75) Inventors: XIU-YI ZHANG, Shenzhen (CN); SHI-SONG ZHENG, Shenzhen (CN); LI HE, Shenzhen (CN)

Correspondence Address: PCE INDUSTRY, INC.;ATT. Steven Reiss, 458 E. LAMBERT ROAD, FULLERTON, CA, 92835, US

(73) Assignees: Fu Zhun Precision Industry (Shen Zhen) Co., Ltd., Shenzhen City (CN); Foxconn Technology Co., Ltd., Tu-Cheng (TW)

(21) Appl. No.: 11/967,031

(22) Filed: Dec. 29, 2007

(30) Foreign Application Priority Data
Oct. 19, 2007 (CN) 200710123993.1

(51) Int. Cl. F21V 33/00; F21V 29/00

(52) U.S. Cl. 362/234; 362/294

(57) ABSTRACT

An LED lamp includes a first heat sink, a lamp base, a plurality of LED modules, an envelope and a second heat sink. The first heat sink includes a cylinder at a centre thereof and a plurality of fins surrounding the cylinder. The lamp base is secured to a bottom portion of the first heat sink. The LED modules are mounted on the fins of the first heat sink. Each of the LED modules includes a printed circuit board and a plurality of LEDs mounted on the printed circuit board. The envelope is mounted between the lamp base and the second heat sink and encloses the first heat sink and the LED modules therein. The second heat sink has a disc-like configuration, with a bottom connecting portion extending through the envelope to connect with a top portion of the first heat sink.

### BACKGROUND OF THE INVENTION

1. Field of the Invention

The present invention relates to a light emitting diode (LED) lamp, and more particularly to an LED lamp having a heat sink for improving heat dissipation efficiency of the LED lamp.

2. Description of Related Art

The technology of LED has been rapidly developed in recent years from indicators to illumination applications. With the features of long-term reliability, environment friendliness and low power consumption, the LED is viewed as a promising alternative for future lighting products. Nevertheless, the rate of heat generation increases with the illumination intensity. This issue has become a challenge for engineers to design the LED illumination, i.e. the LED lamp.

What is needed, therefore, is an LED lamp which has greater heat-transfer and heat dissipation capabilities, whereby the LED lamp can operate normally for a sufficiently long period of time.

### SUMMARY OF THE INVENTION

An LED lamp for a lighting purpose includes a first heat sink, a lamp base, a plurality of LED modules, an envelope and a second heat sink. The first heat sink includes a cylinder at a centre thereof and a plurality of fins surrounding the cylinder. The lamp base is secured to a bottom portion of the first heat sink, adapted for mounting the LED lamp to a lamp socket. The LED modules are mounted on the fins of the first heat sink. Each of the LED modules comprises a printed circuit board and a plurality of LEDs mounted on the printed circuit board. The envelope is mounted between the lamp base and the second heat sink and encloses the first heat sink and the LED modules therein. The second heat sink has a disc-like configuration and extends through the envelope and connects with a top portion of the first heat sink. Heat generated by the LEDs are first absorbed by the fins, and then transferred to the cylinder of the first heat sink and the second heat sink to be dissipated into surrounding atmosphere.

Other advantages and novel features of the present invention will become more apparent from the following detailed description when taken in conjunction with the accompanying drawings, in which:

### BRIEF DESCRIPTION OF THE DRAWINGS

Many aspects of the present apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is a front perspective view of an LED lamp in accordance with a preferred embodiment of the present invention;

FIG. 2 is an exploded, isometric view of the LED lamp of FIG. 1, with an envelope of the LED lamp of FIG. 1 being removed away;

FIG. 3 is an inverted view of FIG. 2;

FIG. 4 shows a first heat sink of the LED lamp of FIG. 2; and

FIG. 5 is an inverted view of FIG. 4.

### DETAILED DESCRIPTION OF THE INVENTION

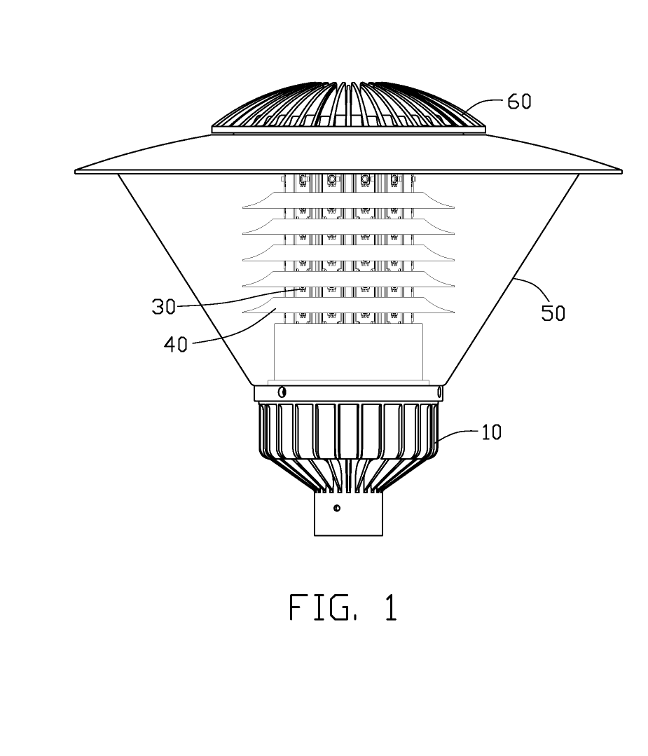

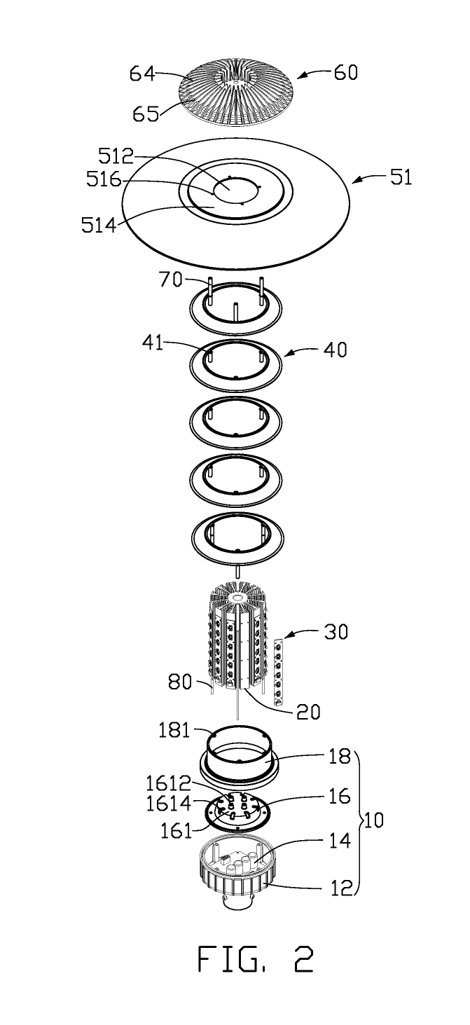

Referring to FIGS. 1-2, an LED lamp for a lighting purpose comprises a plurality of LED modules 30, a first heat sink 20 supporting and cooling the LED modules 30, a plurality of reflectors 40 mounted around the first heat sink 20, a second heat sink 60 located at a top of the first heat sink 20, and a lamp base 10 secured to a bottom portion of the first heat sink 20. An envelope 50 is mounted between the second heat sink 60 and the lamp base 10 for enclosing the first heat sink 20, the LED modules 30 and the reflectors 40 therein. The envelope 50 is made of transparent material, such as glass or plastic.

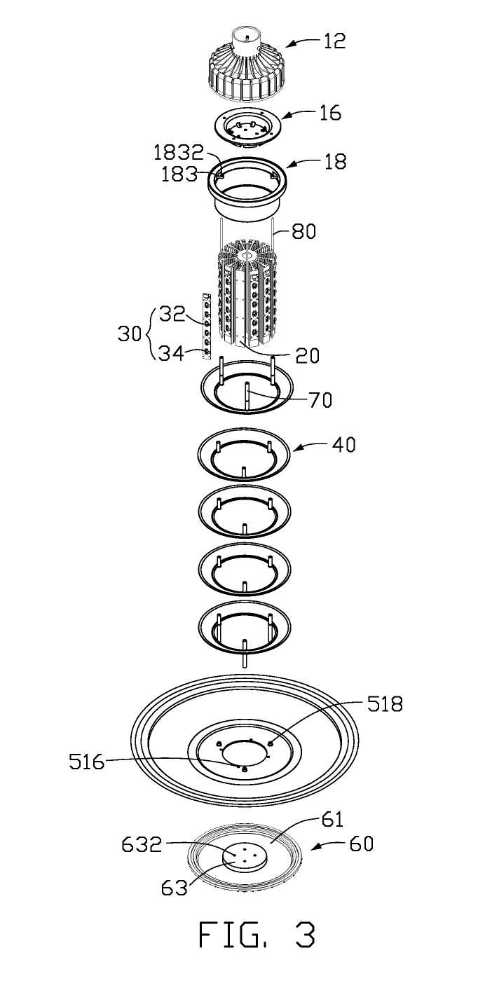

Referring to FIG. 3 also, the lamp base 10 comprises a lamp holder 12, a driving circuit module 14 received in the lamp holder 12, a connecting member 16 mounted on a top portion of the lamp holder 12 and a sleeve 18 engaged with the connecting member 16. The lamp holder 12 is used for inserting the LED lamp into a lamp socket (not shown). The connecting member 16 has a disc-like configuration, and comprises a protrusive, cylindrical mounting portion 161 located at a centre thereof and received in the sleeve 18. Four fixing posts (not labeled) are extended evenly and upwardly from a top plate (not labeled) of the mounting portion 161. Each fixing post defines a screw hole 1612 therein. A plurality of through holes 1614 is radially defined in an edge of the top plate of the mounting portion 161 and surrounds the four fixing posts. Four fasteners (not shown) each have a bottom end engaged in the screw hole 1612 and an upper portion extending through the first heat sink 20 and the second heat sink 60. The sleeve 18 has a hollow, cylindrical configuration. Three tabs 181 equidistantly extend inwardly from a top edge of the sleeve 18. Three protrusions 183 equidistantly extend inwardly from a bottom portion of the sleeve 18, aligning with corresponding tabs 181. Each of the protrusions 183 defines a screw hole 1832 therein. The screw hole 1832 is aligned with a through hole (not shown) defined in a corresponding tab 181. Wires (not shown) extend from the driving circuit module 14 through the through holes 1614 for electrically connecting with the LED modules 30.

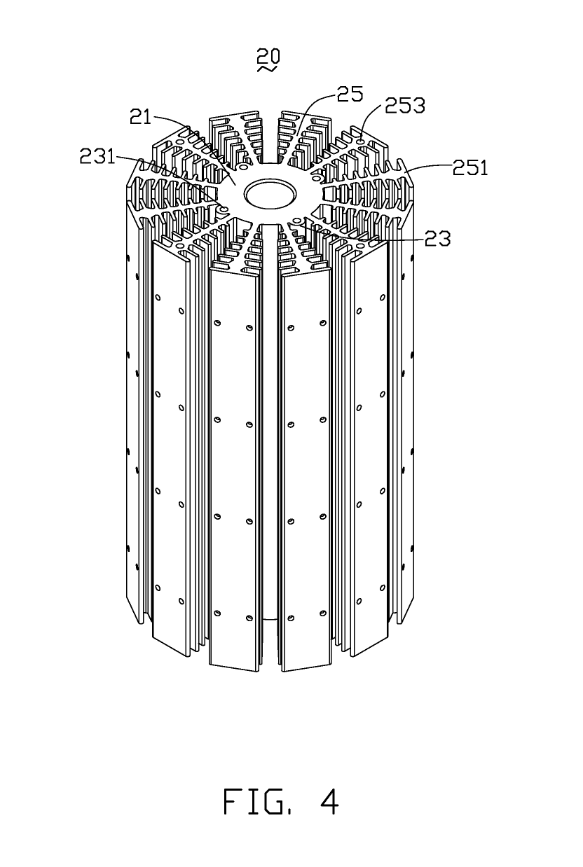

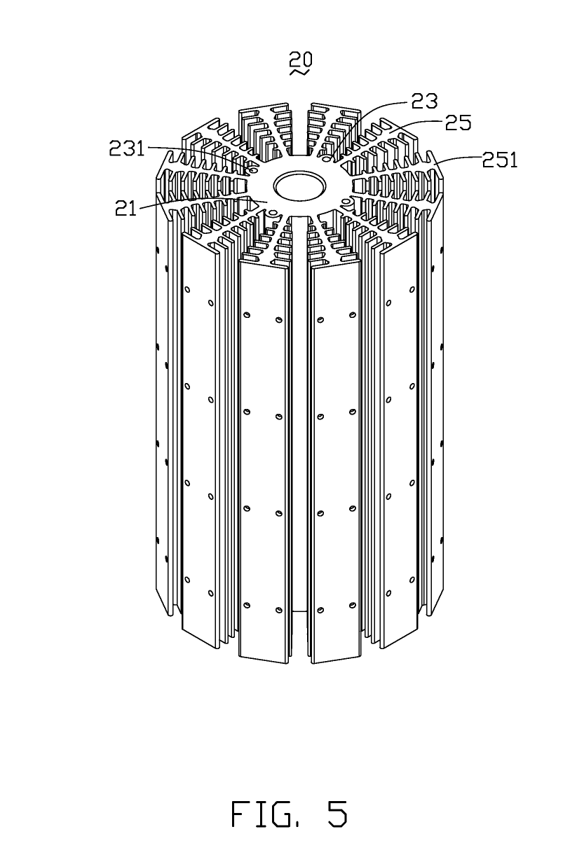

Referring to FIGS. 4-5 also, the first heat sink 20 is integrally formed of a one-piece metal with good heat conductivity, such as aluminum or copper. The first heat sink 20 has a heat-conductive member at a centre thereof. In this embodiment, the heat-conductive member is an elongated cylinder 21 with a through hole (not labeled) defined therein. The first heat sink 20 has a plurality of conducting arms 25 extending radially and outwardly from an out sidewall of the elongated cylinder 21. The conducting arms 25 are identical to each other and centrosymmetric relative to a central axis of the elongated cylinder 21. A quantity of the conducting arms 25 can be different in an alternative embodiment. In this embodiment, the quantity of the conducting arms 25 is designed to be twelve.

A plurality of pairs of outer fins 251 are formed on two opposite lateral sides of each of the conducting arms 25. Each pair of the outer fins 251 extend respectively and perpendicularly from the two opposite lateral sides of each corresponding conducting arm 25, and are symmetrical to each other relative to the corresponding conducting arm 25. The outer fins 251 at a lateral side of each of the conducting arms 25 are increasing in length along a direction from the cylinder 21 to a distal end of the corresponding conducting arm 25. The distal end of the conducting arm 25 terminates at an inner face of an outermost one of the outer fins 251. An outer face of each outermost outer fin 251 is flat and used for thermally contacting with the LED module 30. Four mounting holes 253 are defined in outmost ends of top portions of four of the conducting arms 25, wherein the through holes 253 are centrosymmetric relative to the central axis of the elongated cylinder 21. Four elongated ridges 23 extend outwardly from the out sidewall of the cylinder 21 of the first heat sink 20 and are evenly formed around the cylinder 21. Each ridge 23 is located between two adjacent conducting arms 25. Each of the ridges 23 defines a mounting hole 231 therein aligned with a corresponding screw hole 1612 of the mounting portion 161 of the lamp base 10. The upper portions of the fasteners extend through the mounting holes 231 of the ridges 23. In this state, a bottom portion of the first heat sink 20 is received in the sleeve 18 of the lamp base 10.

Referring to FIGS. 1-3 again, each LED module 30 comprises an elongated printed circuit board 32 and a plurality of spaced LEDs 34 evenly mounted on a front side of the printed circuit board 32. The LEDs 34 of each LED module 30 are arranged along a longitudinal direction of the printed circuit board 32. Each LED module 30 is mounted in a thermally conductive relationship with each of the outer faces of the outermost outer fins 251 of the first heat sink 20.

The envelope 50 has a frustum-like body (not labeled) and a disc-like cover 51. The body has top and bottom openings (not shown) defined therethrough. The cover 51 has a central hole 512 defined therein. The cover 51 forms an annular protrusion 514 around the central hole 512 thereof. An inner periphery of the protrusion 514 defines four through holes 516 therein, which are aligned with the corresponding mounting holes 253 of the first heat sink 20. The cover 51 further defines three screw holes 518 aligned with the through holes of the tabs 181 and the screw holes 1832 of the protrusions 183 of the sleeve 18 of the lamp base 10. Screws (not shown) extend through the through holes 516 of the cover 51 and engage in the mounting holes 253 of the first heat sink 20 to fix the cover 51 on the heat sink 20. The top opening and the bottom opening of the body of the envelope 50 engage with the cover 51 and the top portion of the lamp holder 12 of the lamp base 10 respectively. Therefore, the lamp base 10 and the envelope 50 together define an enclosed housing (not labeled) accommodating the LED modules 30 and the first heat sink 20 therein, whereby the LED modules 30 can have a sufficient protection for preventing from a damage caused by an unexpected force acting on the LED lamp.

Each reflector 40 has an disc-like configuration, and an opening (not labeled) is defined at a center therein. An inner edge of the reflector 40 equidistantly forms three mounting tabs 41. The reflectors 40 are mounted around the printed circuit boards 32. The reflectors 40 are evenly spaced disposed at the periphery of the first heat sink 20 by a plurality of collars 70 aligned with the tabs 41 of the reflectors 40. The collars 70 are located between the conducting arms 25 of the first heat sink 20. A plurality of elongated poles 80 extends through the collars 70, the corresponding tabs 41 of the reflectors 40, and the tabs 181 of the sleeve 18; simultaneously bottom ends of the elongated poles 80 threadedly engage in the corresponding screw holes 1832 of the protrusions 183 of the sleeve 18 and top ends of the elongated poles 80 engage in the screw holes 518. Thus, the reflectors 40 are secured to the periphery of the first heat sink 20. The reflectors 40 improve the illumination of the LED lamp by redirect light rays generated by the LEDs 34 into a more consistently outward and downward direction.

The second heat sink 60 has a disc-like configuration and is made of high heat conductive metal, such as aluminum. The heat sink 60 comprises a base 61 (shown in FIG. 3), a connecting portion 63 facing the first heat sink 20 and extending from a centre of the base 61 and a plurality of first and second fins 64, 65 radially formed on a top face of the base 61. The connecting portion 63 has a round shape and four mounting holes 632 evenly defined therein. The first and the second fins 64, 65 extend inwardly from an outmost edge of the base 61 to a central of the heat sink 60. Each of the first fins 64 has a length longer than that of each of the second fins 65. The first fins 64 and second fins 65 are alternate and spaced apart evenly with each other. The connecting portion 63 of the second heat sink 60 extends through the central hole 512 of the cover 51 and rests on the top portion of the first heat sink 20. The upper portions of the fasteners which have bottom ends engaging in the screw holes 1612 extend through the mounting holes 231 of the first heat sink 20 and further extend through the mounting holes 632 of the second heat sink 60 to threadedly engage with nuts (not shown) to thereby fix the second heat sink 60 on the top portion of the first heat sink 20. Thus, the second heat sink 60 is located at a centre of the cover 51 of the envelope 50. Thermal grease (not labeled) is sandwiched between the connecting portion 63 of the second heat sink 60 and the top portion of the first heat sink 20 to improve heat transferring efficiency from the first heat sink 20 to the second heat sink 60.

When the LEDs 34 emit light, heat generated by the LEDs 34 is conducted to the first heat sink 20, then rapidly transfers to the base 61 of the second heat sink 60, and finally dispersed into ambient cool air via the first and second fins 65, 67 mounted on the top face of the base 61 of the second heat sink 60. Therefore, temperature of the enclosed housing defined by the lamp base 10 and the envelope 50 is decreased. Thus it can be seen that the LED lamp has an improved heat dissipating configuration for preventing the LEDs 34 from overheating.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An LED lamp adapted for a lighting purpose comprising:
a first heat sink comprising a cylinder at a centre thereof and a plurality of fins surrounding the cylinder;
a lamp base secured to a bottom portion of the first heat sink, adapted for connecting the LED lamp to a lamp socket;
a plurality of LED modules being mounted on the fins of the first heat sink, each of the LED modules comprising a printed circuit board and a plurality of LEDs mounted on the printed circuit board;
an envelope mounted on the lamp base and enclosing the first heat sink and the LED modules therein; and
a second heat sink having a disc-shaped configuration and extending through the envelope and connecting with a top portion of the first heat sink.

2. The LED lamp of claim 1, wherein the second heat sink comprises a base, a connecting portion extending downwardly from the base to connect with the first heat sink and a plurality of radial first and second fins on an upper surface of the base.

3. The LED lamp of claim 2, wherein the connecting portion has a round configuration and extends through the envelope to connect with the top portion of the first heat sink.

4. The LED lamp of claim 2, wherein the first and the second fins extend inwardly from an outmost edge of the base to a center of the second heat sink and the first fins and the second fins of the second heat sink are alternate and evenly spaced with each other, and each of the first fins has a length longer than that of each of the second fins.

5. The LED lamp of claim 1, wherein the envelope comprises a body mounted on the lamp base and a cover mounted on a top of the body, and the second heat sink is located at a centre of the cover of the envelope.

6. The LED lamp of claim 1, wherein the first heat sink has a plurality of conducting arms extending outwardly from an outer sidewall of the cylinder, and the fins are formed on two opposite lateral sides of each of the conducting arms.

7. The LED lamp of claim 6, wherein the fins of each of conducting arms are perpendicularly to and symmetrical to each other relative to the each of the conducting arms, and the fins at a lateral side of the each of the conducting arms are increasing in length along a direction from the cylinder to a distal end of the each of the conducting arms.

8. The LED lamp of claim 7, wherein the distal end of the each of the conducting arms terminates at an inner face of an outermost one of the fins and an outer face of each outermost fin is flat and a corresponding LED module is mounted on the outer face of the each outermost fin.

9. The LED lamp of claim 1 further comprising a plurality of spaced reflectors mounted around the LED modules.

10. The LED lamp of claim 9, wherein the reflectors are spaced from each other by a plurality of collars located therebetween and elongated poles extend through the collars and the reflectors to engage with the lamp base and the envelope to thereby mount the reflectors around the first heat sink.

11. The LED lamp of claim 10, wherein each of the reflectors has a disc-shaped configuration.

12. An LED lamp comprising:
a first heat sink having a cylinder and a plurality of fins surrounding the cylinder;
a second heat sink having a bottom portion intimately connecting with a top of the first heat sink;
a lamp base connecting with a bottom of the first heat sink;
an envelope mounted between the lamp base and the second heat sink; and
a plurality of LED modules mounted on the fins of the first heat sink, each LED module having a printed circuit board and a plurality of LEDs mounted on the printed circuit board;
wherein the envelope encloses the LED modules and heat generated by the LEDs is absorbed by the fins of the first heat sink and then transferred to the second heat sink.

13. The LED lamp of claim 12, wherein the second heat sink has fins radially extending from a center of the second heat sink to an outer edge thereof.

14. The LED lamp of claim 12 further comprising a plurality of reflectors enclosed by the envelope and mounted around the first heat sink and the LED modules.

15. The LED lamp of claim 12, wherein the first heat sink has a plurality of conducting arms extending radially outwardly from an outer periphery of the cylinder and the fins of the first heat sink are formed at distal ends of the conducting arms.
